(19) United States
(12) Patent Application Publication
(10) Pub. No.: US 2009/0022926 A1
(43) Pub. Date: Jan. 22, 2009

(54) LABEL

(75) Inventor: Akira Dangami, Tokyo (JP)

Correspondence Address: LOWE HAUPTMAN HAM & BERNER, LLP, 1700 DIAGONAL ROAD, SUITE 300, ALEXANDRIA, VA, 22314, US

(73) Assignee: LINTEC CORPORATION, TOKYO (JP)

(21) Appl. No.: 11/817,871

(22) PCT Filed: Mar. 14, 2006
(86) PCT No.: PCT/JP2006/304978

§ 371 Date: Sep. 5, 2007

(30) Foreign Application Priority Data
Mar. 29, 2005 (JP) 2005-094347

(51) Int. Cl. G09F 3/03; B32B 33/00; B42D 11/00; G09F 3/02

(52) U.S. Cl. 428/42.2; 428/43

(57) ABSTRACT

A label L is formed to include a first label area L1 and a second label area L2 which is folded back to a rear surface side of the first label L1. The second label area L2 is stuck to an adhesive layer 11 side of the first label area L1 so that a printed surface thereof is positioned at an adherend side and when a part of the adhesive layer 11 is stuck to the adherend, a state that the printed surface is concealed is maintained. Confirmation and storage of the printed information on the second label area L2 is carried out through tearing off along tear-off lines 13, 14, 15 and 17.

### FIELD OF THE INVENTION

The present invention relates to a label, in particular to a label, in which a second label area can be folded back to a rear surface of a first label area and the first label area can be stuck to an adherend and thereby information printed on the second label area can be concealed.

### BACKGROUND OF THE ART

Recently, accompanying a global expansion of Internet, TV shopping and the like, mail-order sale has come into wide use in addition to a conventional over-the-counter sale. Accordingly, logistics models in which a delivery agent delivers an article in place of a seller have been widespread. For this reason, there is a possibility that information about the article, for example, article description, price of the article or the like may be leaked out through a delivery slip. Such information specifies the article purchased by a consumer, which is secret information seriously affecting the privacy of the consumer. Since the price of the article has such feature that the value of the article can be comprehended, the price of the article is preferably regarded as a piece of secret information in view of theftproof in the process of logistics.

In this respect, when the delivery slip has such a structure that a plurality of sheets of forms are laminated and stacked into a bundle, the article description, sum of the money to be received and the like are described in a part of the delivery slip and the article can be handed over to the consumer in a state that the confidentiality is ensured. However, when a delivery slip of this type is employed, available label printer therefor is limited.

The patent document 1 discloses a label usable as a sheet type delivery slip. The label is a sheet type label including a secret information form portion continuous with an open information form portion. The label is arranged in such a way that the secret information form portion is turned over to the rear face side of the open information form portion, and the open information form portion is stuck to an adherend, and thereby the secret information form portion is concealed from the outside.

[Patent document 1] Japanese Patent Application Laid-Open No. 2001-246882

### DISCLOSURE OF THE INVENTION

### Problem to be Solved by the Invention

However, the label set forth in the patent document 1 has such an arrangement that an adhesive layer is provided on the entire area of the rear surface of the open information form portion and secret information form portion, therefore, there is a disadvantage that the adhesive layer is consumed uselessly.

Also, although the label set forth in the patent document 1 ensures the confidentiality during delivery, the label has such a structure that, when a deliverer tears off the delivery slip and receives a signature from the receiver, the receipt slip that is a secret information portion is exposed to the deliverer. Since the receipt slip carries personal information concerned with the privacy such as article description, the function as a concealing label is not satisfied.

Further, although the document portion indicating various kinds of information can be handled as a bundle, when a function as a warranty form is granted, the label cannot be applied to a case that a part of the label is torn off and enclosed in a packaging case to ensure the reception of the consumer.

That is, in the label of the patent document 1, the adhesive layer is provided to the entire area of the rear surface of the label, and when sticking the label, the release liner is removed. Therefore, such option that a part of the label is torn off and enclosed in a packaging case is not applicable.

### OBJECT OF THE INVENTION

The present invention has been proposed in view of the above disadvantages. It is an object of the present invention to provide a label capable of reducing an area of the adhesive layer with respect to an entire plane area of the label to avoid useless consumption of the adhesive layer.

Another object of the present invention is to provide a label that has such an applicable option of usage arrangement depending on the necessity that a part of the label can be enclosed directly in a packaging container of an article or the like.

### Means for Solving Problems

To achieve the above object, the present invention employs a label including a first label area having an adhesive layer on a rear surface side thereof and a second label area continuous with the first label area, wherein when the second label area is folded back to the adhesive layer side of the first label area and stuck thereto, a tear-off line has been formed along an outer edge of the second label area, and an exposed portion of the adhesive layer on the first label area is provided so as to be stuck to an adherend and to be able to conceal information printed on the second label area.

The present invention may employ such an arrangement that the second label area is provided with tear-off lines so that the second label area can be divided into plural segments.

Also, when the second label area is folded back to the adhesive layer side of the first label area, a part of the second label area may be arranged to protrude from the first label area to form turning-over sections for tear-off operation.

Further, such an arrangement may be employed that notches to form the turning-over sections are provided in a boundary area between the first and second labels.

Furthermore, notches to form turning-over sections for tear-off operation are provided in a peripheral portion of the first label.

Still further, such an arrangement may be employed that the first and second label areas are arranged so that indication areas are segmented vertically or laterally via tear-off lines, and punch-out portions for exposing the adhesive layer are formed within one of the indication areas in the second label area.

Still furthermore, such an arrangement may be employed that the first and second label areas are arranged to have indication areas segmented vertically or laterally, and the indication areas in the second label area are disposed discontinuously with each other.

Further, such an arrangement may be employed that turning-over sections for tear-off operation are formed in the surface of the first label area when the second label area is folded back to the first label area.

### EFFECT OF THE INVENTION

According to the present invention, since the adhesive layer is provided in the first label area only, waste of the adhesive layer can be saved by an amount equivalent to the plane area of the second label area. Also, since the second label area has no adhesive layer, the second label area can be cut off from the first label area. Depending on the necessity, the second label area can be used in such a way that the second label area is cut off beforehand and enclosed in a packaging case. Further, when the first label area is stuck onto the adherend, since the printed surface of the second label area can be maintained to position at the adherend side, therefore, the secret information printed on the second label area can be concealed.

Further, since the area where the second label area is stuck to the adhesive surface of the first label area is not stuck to the adherend, the second label area can be easily torn off along the tear-off line and stored thereafter. In that case, tear off operation can be carried out extremely easily by using the turning-over section.

Further, in the arrangement in which the punch-out portion are formed within the second label area, since the sticking area to the adherend in the adhesive layer of the first label area is increased through the punch-out portions, disposing of adhesive areas in plural areas can further enhance the concealing performance.

### BRIEF DESCRIPTION OF THE DRAWINGS

FIG. 1 is a plane view of a label showing a first embodiment.

FIG. 2 is a cross-sectional view along a line A-A in FIG. 1.

FIG. 3 is a plane view showing a state of the label in use.

FIG. 4 is a plane view of a label showing a second embodiment.

FIG. 5A is a plane view showing a state of the label in use according to the second embodiment, and FIG. 5B is a cross-sectional view along a line B-B in FIG. 5A.

FIG. 6 is a plane view of a label according to a third embodiment.

FIG. 7 is a plane view showing a state of the label in use according to the third embodiment.

FIG. 8 is a plane view of a label according to a fourth embodiment.

FIG. 9 is a plane view showing a state of the label in use according to the fourth embodiment.

FIG. 10 is a plane view of a label according to a fifth embodiment.

FIG. 11 is a plane view of a label according to a sixth embodiment.

FIG. 12 is a plane view of a label according to a seventh embodiment.

### EXPLANATION OF REFERENCE NUMERALS

10: extension area
11: adhesive layer
13: central tear-off line
14: upper tear-off line
15: lower tear-off line
17: intermediate tear-off line
20, 21, 26, 40, 50: turning-over section
30, 31: punch-out portion
L: label
L1: first label area
L2: second label area

### BEST MODE FOR CARRYING OUT THE INVENTION

Referring to the drawings, preferred embodiments of the present invention will be described below.

### First Embodiment

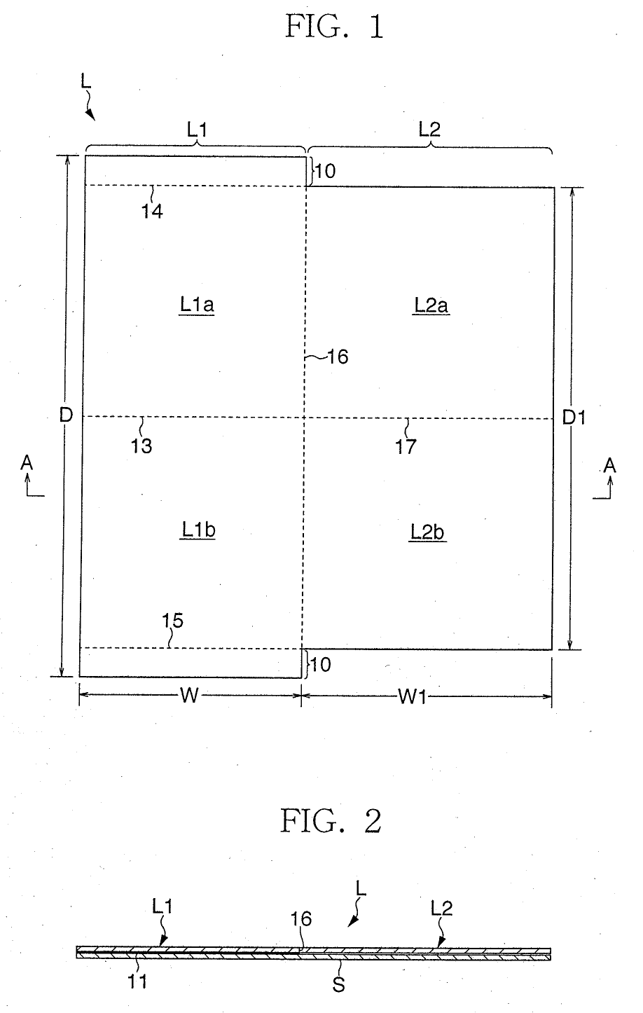

FIG. 1 shows a schematic plane view of a label according to a first embodiment, and FIG. 2 shows a cross-sectional view thereof. A label L shown in these figures is particularly suitable to be used as a slip for article delivery or the like. The label L includes a first label area L1 and a second label area L2 formed continuously with the first label area L1 at the right end side thereof in the figure. The label L is arranged so that, on the first label area L1, receiver's address etc. of the article or the like is indicated, while on the second label area L2, an article receipt section, detailed statement of article prices, amount of money to be received and the like are indicated.

The first and second label areas L1, L2 has generally a rectangular shape with a portrait format, although not limited to that particularly. The width W in a lateral direction of the first label area L1 is arranged to be smaller than the width W1 in the lateral direction of the second label area L2 by approximately 10 mm. Also, the length D in a vertical direction of the first label area L1 is arranged to be longer than the length D1 in a vertical direction of the second label area L2 by approximately 10 mm at each end. Owing to this arrangement, on the upper and lower ends of the first label area L1, extension areas 10, 10 are formed, each of which has a rectangular shape longer in the lateral direction with respect to the identical lines at the upper and lower ends of second label area L2.

On the rear surface side of the first label area L1, an adhesive layer 11 is provided and a release liner S covers the adhesive layer 11 as shown in FIG. 2. In this embodiment, for the convenience sake of processing, the release liner S is arranged so as to have a width extending to the rear surface side of the second label area L2 as well. However, the release liner S may be provided only in the area of the adhesive layer 11.

In the central area of the first label area L1 in the vertical direction in FIG. 1, a central tear-off line 13 is formed by perforations or the like and extends along the lateral direction. Likewise, in the upper and lower portions of the first label area L1, an upper tear-off line 14 and a lower tear-off line 15 are formed respectively on the boundary lines between each of the extension areas 10, and the first label area L1. Owing to this arrangement, the first label area L1 is divided into two segments; i.e., a first upper area L1a and a second lower area L1b. The right edge of the first label area L1, that is, the boundary portion between the second label area L2 and the first label area L1 is provided with a fold-back line 16 formed of perforations or the like.

In a central area of the second label area L2 in the vertical direction, an intermediate tear-off line 17, which extends on a line substantially identical to the central tear-off line 13, is formed. The upper and lower portions with respect to the intermediate tear-off line 17 are formed as a second upper area L2a and a second lower area L2b.

When the label L is used, printing can be carried out using a printer (not shown) on the first label area L1 and the second label area L2. In that case, in the first upper area L1a of the first label area L1, an address, a name or appellation of a receiver of the article is printed. On the other hand, in the first lower area L1b, it is preferable that such information as address and name or appellation of a sender, which are not required to be concealed but are the necessary minimum information for a deliverer is printed. Depending on the kind of the article, there may be a case where the name or appellation of the sender is indicated with a personal name such as a representative's name or the like in place of a corporate name. That is, some articles can be guessed to a certain extent from the corporate name. In the case where there is a possibility of theft, a personal name may be indicated on the label L1 and the corporate name may be separately indicated on the second label area L2.

On the second label area L2, article receipt section, article description, amount of money to be received, breakdown thereof and the like are printed. When the receipt section is printed, for example, in the second upper area L2a, the deliverer can tear off the second upper area L2a together with the first upper area L1a and bring them back to verify that the correlation with the receiver has been retained. When article description, amount of money to be received, breakdown thereof and the like are printed on the second lower area L2b, the information to be concealed can be confirmed only by the receiver without being exposed to anyone else.

In the printed label L after the release liner S is peeled off, the second label area L2 is folded back along the fold-back line 16, and the adhesive layer 11 of the first label L1 and the rear surface, i.e., the reverse surface of the printed surface of the second label area L2 are stuck with each other.

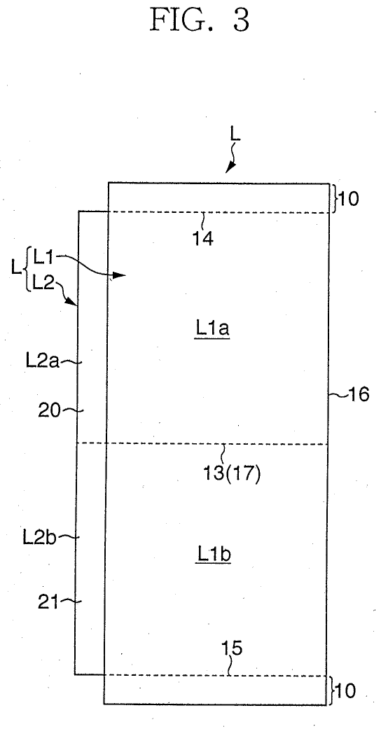

In the label L, where folding and sticking has been carried out, the free end side of the second label area L2, i.e., the right end side area in FIG. 1 protrudes about 10 mm from the left end of the first label area L1, and thus an upper turning-over section 20 and a lower turning-over section 21 for tear-off operation are formed as shown in FIG. 3. In this state, the adhesive layer 11 is exposed at the rear surface side of the extension areas 10, 10, which are located at the upper and lower portions of the first label area L1, and thereby the label L can be stuck to a packaging container of the article as an adherend (not shown) via the adhesive layer 11.

When the article stuck with the label L is delivered, in the case where the second upper area L2a is, for example, a receiving slip indicating the article reception, the receiving slip can be brought back after tearing off the second upper area L2a, by nipping the upper turning-over section 20, along the upper tear-off line 14, the central tear-off line 13 and the intermediate tear-off line 17 that is overlapped with the tear-off line 13.

On the other hand, in the case where the lower area L2b of the second label L2 is a receipt, by tearing off the lower area L2b along the lower tear-off line 15, the receiver can confirm and store without exposing the same to anyone else.

Therefore, according to the first embodiment as described above, such a label can be provided that secret information can be printed on the second label L2 and the label can be stuck in a state that the information is concealed.

Also, since the second label area L2 has no adhesive layer, the second label area L2 may be previously torn off from the first label area before use and be enclosed in a packaging container of an article to assure to be received by the article receiver.

Next, embodiments of the present invention other than the above-described embodiment will be described. It should be noted that, in the following descriptions, identical or equivalent components among the following embodiments with the first embodiment will have the identical reference numerals and descriptions thereof will be omitted or made to be brief.

### Second Embodiment

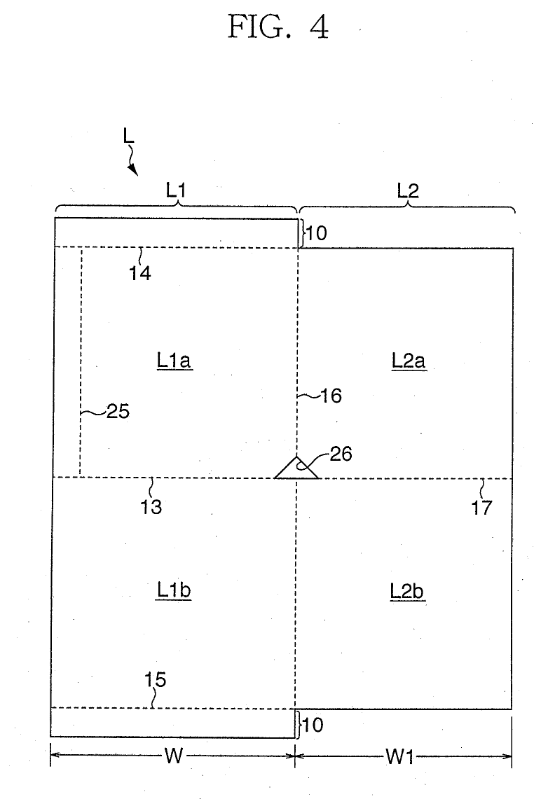

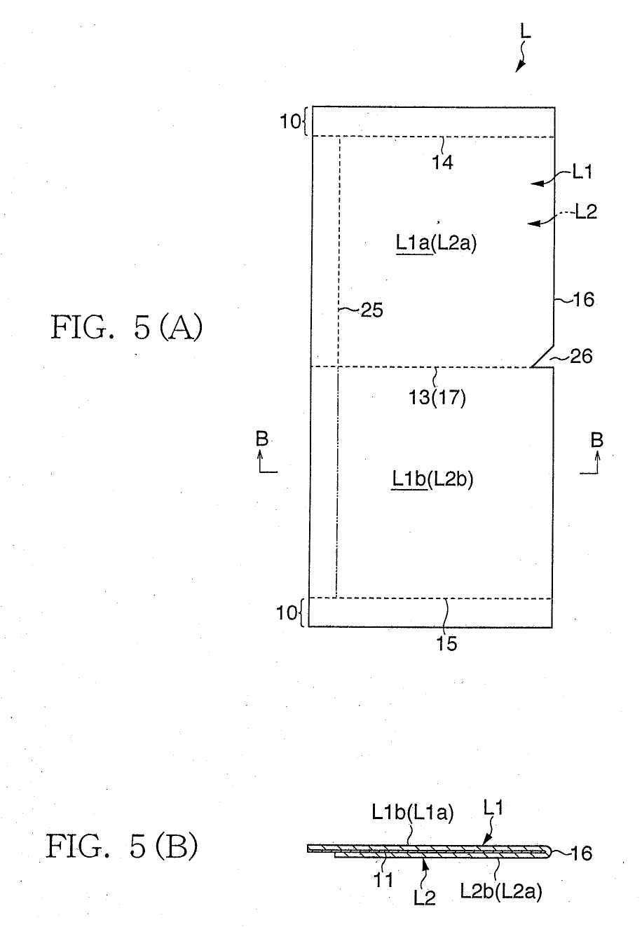

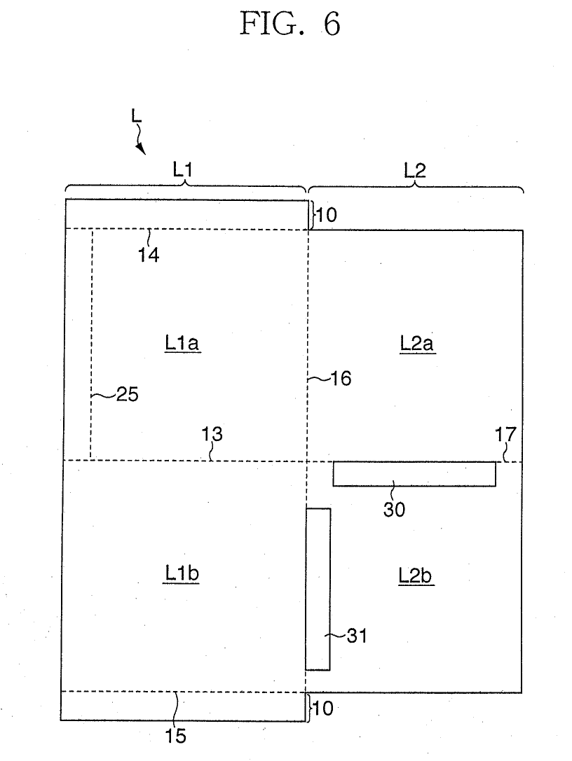

FIG. 4 and FIG. 5 show a second embodiment of the present invention. In this embodiment, the second label area L2 is arranged so that the width W1 in lateral direction is smaller than the width W in lateral direction of the first label area L1 by approximately 10 mm. As shown in FIG. 5B, when the second label area L2 is folded back to the adhesive layer 11 of the first label area L1, the adhesive layer 11 is exposed extending in a vertical direction in an area of approximately 10 mm of the first label area L1 at the left end side thereof in FIG. 4. When the adhesive layer 11 exposed in a vertical direction as described above and the adhesive layer 11 at the rear side of the extension areas 10, 10 located at the upper and lower portions of the first label area L1 are stuck onto the adherend, the first label area L1 is arranged to form a open-pocket at the right end side thereof. Also, a tear-off line 25 is formed at the left side of the first upper area L1a in a vertical direction; and further as shown in FIG. 5A, a notch as a turning-over section 26 is formed at a point along the fold-back line 16.

The second upper area L2a and the first upper area L1a corresponding thereto are arranged so as to be torn off along the tear-off line 25, the central tear-off line 13 and the intermediate tear-off line 17 and the upper tear-off line 14. The tear-off operation can be performed easily by nipping the turning-over section 26 by a finger tip and pulling up the same. In the first lower area L1b, although the left side thereof where is not overlapped with the second lower area L2b is stuck to the adherend, the second lower area L2b can be torn off and stored by forcibly tearing off the same.

Therefore, in the above-described embodiment also, an effect identical with the first embodiment is obtained, and since the label L is stuck in three areas in a pocket-like configuration, a stable stuck can be achieved.

### Third Embodiment

FIG. 6 shows a third embodiment of the present invention. The third embodiment is a modified mode of the second embodiment, and is characterized in that, in the upper and left end sides within the surface of the second lower area L2b, punch-out portions 30, 31 each having an outline of a substantially rectangular shape are provided.

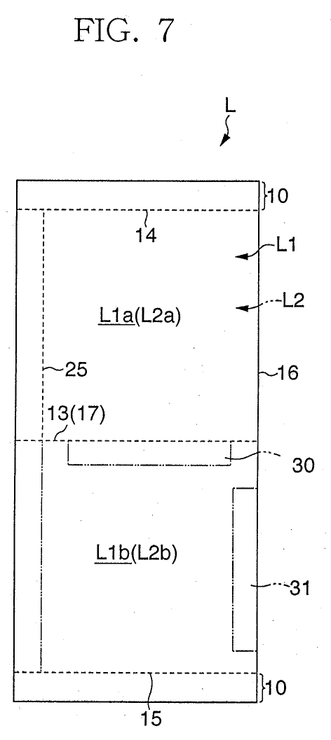

Therefore, as shown in FIG. 7, in a state that the second label area L2 is folded back and the label L is going to be stuck onto the adherend, the adhesive layer 11 of the first lower area L1b is exposed along the four edges thereof. Therefore, the performance to conceal the information printed on the second lower area L2b can be further increased. Particularly, in the case of the label having a large plane area, such a disadvantage can be eliminated that the area along the fold-back line 16 floats up or waves, resulting in an unintended peel off of the label L during its transportation. Further, when the deliverer tears off the second upper area L2a together with the first upper area L1a, the second lower area L2b is prevented from being rolled up and the secret information is not exposed to the deliverer. Thus, the concealing performance is increased.

### Fourth Embodiment

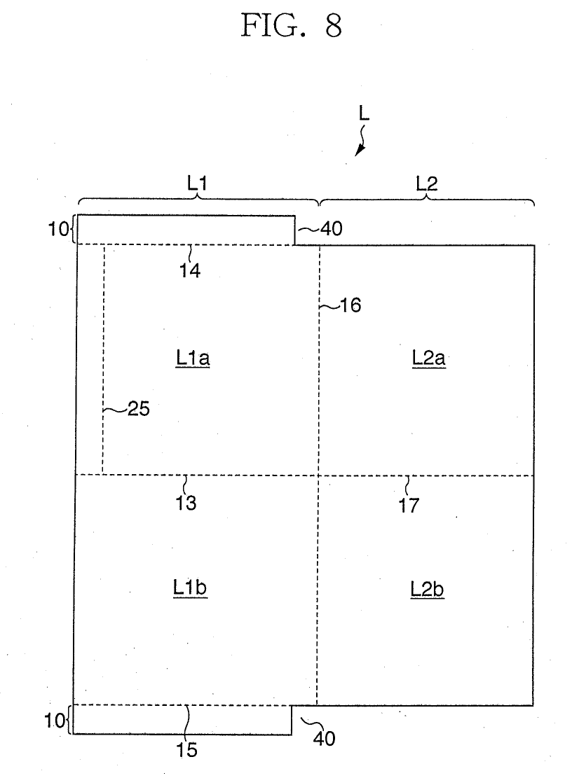

FIG. 8 shows a fourth embodiment of the present invention. The fourth embodiment is further modified mode of the second embodiment.

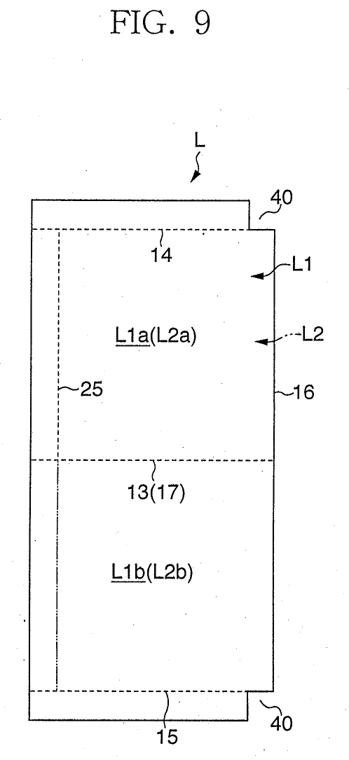

That is, the right ends of the extension areas 10, 10 in the first label area L1 in FIG. 8, are displaced leftward from the position of the fold-back line 16. When the second label area L2 is folded back to the rear surface side of the first label area L1 as shown in FIG. 9, an L-shaped notch is formed at the right end side of the extension area 10 so that the notches form the turning-over sections 40 for tear-off operation.

In the above-described embodiment also, an effect identical with the second embodiment can be obtained.

### Fifth Embodiment

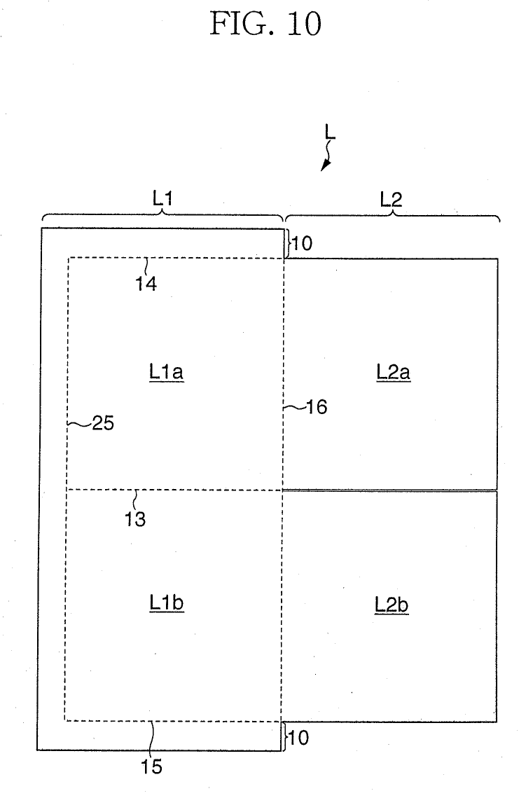

FIG. 10 shows a fifth embodiment of the present invention. The fifth embodiment is characterized in that the second upper area L2a and the second lower area L2b constituting the second label L2 are arranged to be separated from each other having a slight gap therebetween, and the adhesive layer 11 of the first label area L1 is exposed along three edges excluding the area at the fold-back line 16 side.

In the fifth embodiment as described above, same as the second embodiment, the first label area L1 is stuck in a sack-like configuration like a pocket which has an opening at the fold-back line 16 side. Therefore, since the tear-off lines are not overlapped with each other, the second upper area L2a and the second lower area L2b can be torn off easily.

### Sixth Embodiment

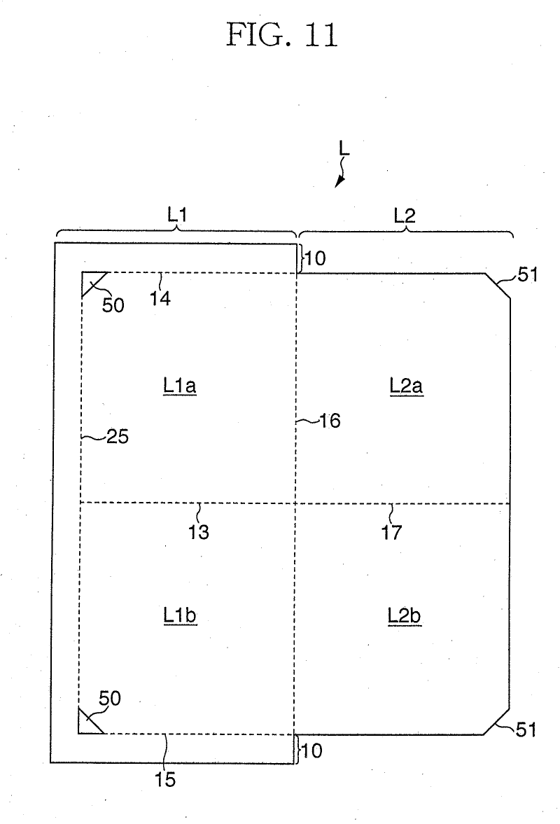

FIG. 11 shows a sixth embodiment of the present invention. The sixth embodiment is a modified mode of the fifth embodiment, and is characterized in being arranged as described below. That is, in the surface of the first label area L1, notches as turning-over sections 50 for tear-off operation are formed along the corner of the tear-off line in the left-upper portion of the first upper area L1a and in the left-lower portion of the first lower area L1b, and at the corresponding corner portions of the second upper area L2a and the second lower area L2b, cut-off edges 51 are formed; and when the second label area L2 is folded back to the first label area L1 side, the oblique lines of the cut-off edges 51 correspond to the oblique lines of the turning-over sections 50.

In the embodiment as described above, by nipping one of the turning-over sections 50 with finger tips, the second upper area L2a and the second lower area L2b can be turned over thereby tearing off the same.

### Seventh Embodiment

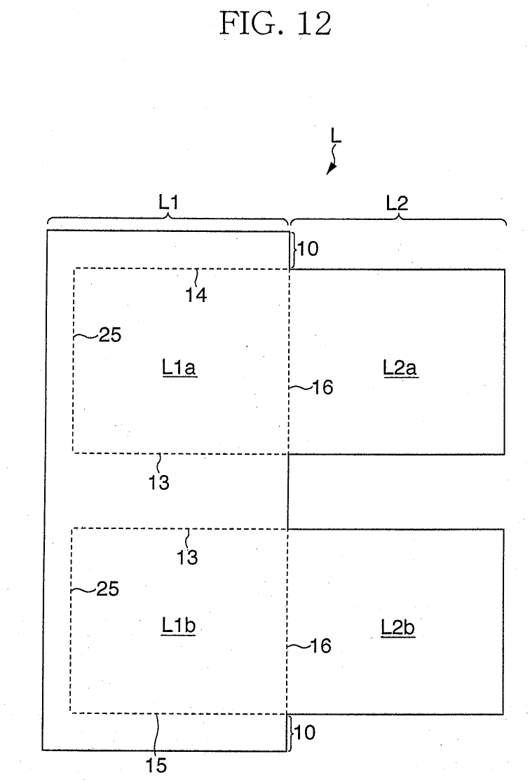

FIG. 12 shows a seventh embodiment of the present invention. The seventh embodiment is characterized in that the second upper area L2a and the second lower area L2b are arranged being largely separated away from each other in the vertical direction, and the central tear-off line 13 in the first label area L1 is separated into two in the vertical direction, and the adhesive layer 11 is exposed therebetween so as to be stuck to the adherend.

In the embodiment as described above, two pockets having a half or smaller opening width of the pocket illustrated in FIG. 10 can be formed, thereby concealing the secret information can be more effectively.

The best arrangement and method for carrying out the present invention have been disclosed so far. However, the present invention is not limited to the above.

That is, the present invention has been illustrated and described mainly about specific embodiments. However, it is possible for those skilled in the art to add various modifications, if necessary, to the above-described embodiments with respect to the shape, position and/or disposition without departing from the technical spirit and the range of the object of the present invention.

For example, the plane configuration of the first and second label area L1, L2 are not limited to a rectangular shape, but various plane shapes having such as polygonal, circular or elliptical shape may be targeted. In other words, the present invention allows various design changes as long as printing is performed on the label and the label can be stuck in a state that the secret information is concealed.

Also, the present invention may be arranged so that structural components in the respective embodiments may be appropriately combined with others so as to be applied in other embodiments within a range capable of implementing practically.

1. A label including a first label area having an adhesive layer on a rear surface side thereof and a second label area continuous with the first label area,
wherein when said second label area is folded back to the adhesive layer side of the first label area and stuck thereto, a tear-off line is formed along an outer edge of the second label area, and an exposed portion of the adhesive layer on the first label area is provided so as to be stuck to an adherend and to be able to conceal information printed on the second label area.

2. The label according to claim 1, wherein said second label area is provided with tear-off lines so that the second label area can be divided into plural segments.

3. The label according to claim 1, wherein, when said second label area is folded back to the adhesive layer side of the first label area, a part of said second label area protrudes from the first label area to form turning-over sections for tear-off operation.

4. The label according to claim 1, wherein notches to form said turning-over sections are provided in a boundary area between said first and second labels.

5. The label according to claim 1, wherein notches to form turning-over sections for tear-off operation are provided in a peripheral portion of said first label.

6. The label according to claim 1, wherein said first and second label areas are arranged so that indication areas are segmented vertically or laterally via tear-off lines, and punch-out portions for exposing said adhesive layer are formed within one of the indication areas in the second label area.

7. The label according to claim 1, wherein said first and second label areas are arranged to have indication areas segmented vertically or laterally, and the indication areas in the second label area are disposed discontinuously with each other.

8. The label according to claim 1, wherein turning-over sections for tear-off operation are formed in the surface of the first label area when the second label area is folded back to said first label area.
